(19) United States
(12) Patent Application Publication
(10) Pub. No.: US 2005/0160176 A1
(43) Pub. Date: Jul. 21, 2005

(54) System and method for remote data processing and storage

(76) Inventors: W. Brent Seales, Nicholasville, KY (US); James N. Griffioen, Lexington, KY (US); Kenneth L. Calvert, Lexington, KY (US)

Correspondence Address: STOLL, KEENON & PARK, LLP, 300 W. VINE STREET, SUITE 2100, LEXINGTON, KY, 40507, US

(21) Appl. No.: 10/761,733

(22) Filed: Jan. 21, 2004

(51) Int. Cl. G06F 15/16

(52) U.S. Cl. 709/229

(57) ABSTRACT

A system and method for remote data processing and storage includes a remote data processing and storage device operational remotely from a data exchange infrastructure using a virtual interface and certain protocols to direct data traffic and use, and for security, programs for sharing and access, and a business method for commercial utilization of the system based on fee-charged system use, and for data product sales, and for verification of data.

### BACKGROUND OF THE INVENTION

The present invention is related broadly to computer networks and, more particularly, to a computer network that provides seamless remote interoperability for a remote date processing and storage.

Fundamental to the operation of a computer is its ability to interact with a human user. Such interaction is provided by interface devices that must be sized to accommodate such users. As miniaturization takes computers ever smaller in size, interface devices such as keyboards and displays are susceptible to miniaturization limits based on their ability to interact with human computer users. Accordingly, computers have been constricted in utility because of the interface components defining limits of miniaturization. This is especially true in mobile systems, where users are required to choose between reasonably usable displays and reasonable portability.

Even considering the foregoing, computing power per unit volume has increased steadily over the years and should continue to do so for years to come. Computing power and storage that once formed a desktop system is now available in a case that will fit in the palm of a user's hand. Wearable systems that may be carried on a belt or sewn into clothing are becoming a reality. Concurrently, advances in battery technology and the growing deployment of wireless data communication have made it possible to be connected almost anywhere at anytime. Nevertheless, before personal computing devices that will go anywhere become truly useful, the user interface problem must be addressed. Simply stated, human interfaces need to be human sized.

Miniature displays are somewhat useful but the standard model of integrating user interface technology with computing technology limits the paths of both. Handheld devices such as the PALM® computing devices, IPAQ® computing devices, and many others exemplify this problem. The integrated user interface hardware which may include a touchscreen and a few buttons consumes a large portion of the engineering effort and final costs yet limits the set of applications that can be usefully run on a computing system. Freed from the requirements of integrated display and input devices, a system the size of a matchbox or smaller could host much more powerful and sophisticated computing applications while allowing users to easily carry their normal personal computing environment and data with them at all times.

Unity of design with regard to the computer and the interface also limits the ability to adapt interfaces to special needs. Elderly persons or those with certain disabilities may have difficulty with some standard interface devices, such as a mouse.

All of the above factors can limit the commercial viability of computers as merchants of data products. Data products can include not only computer software, but music and other entertainment recordings fixed in a digital medium. Currently, most computer-based commercial transactions occur in businesses or the home where computer systems are present or through the use of wireless laptop computers. Such computers are normally carried by people in the course of their business and most people do not specifically carry laptops on shopping expeditions.

As an example, music can currently be purchased in a digital format by purchasing prerecorded CD ROMs and DVD's while movies, instructional recordings and other video entertainment may be purchased on prerecorded DVD's. Computer software can appear on either format. Most direct digital transfers currently take place utilizing the worldwide web and home computers. Currently, there exists a need for a system that will allow a user to enter a store, download the requested data and carry on with the purchased data in a portable, personal data processing and storage device. There also exists a need for a computing system that can be developed and implemented using separable user interfaces.

### SUMMARY OF THE INVENTION

An object of the present invention is to provide a remotely actuable computing system for data processing and storage that uses separate user interfaces. In addition, the present invention may be configured to provide remotely actuable data access to facilitate commercial transactions.

To those ends, the present invention, according to one preferred embodiment thereof, includes a remote data processing and storage device for wireless, two-way data transfer communication with one or more data exchange infrastructure devices. The present remote data processing and storage device includes a housing; a power supply disposed within the housing; a microprocessor in electrical communication with the power supply and disposed within the housing; a data memory storage unit in electrical communication with the power supply and disposed within the housing; a transmitter and receiver assembly in electrical communication with the microprocessor and the power supply, with the transmitter and receiver assembly being disposed within the housing for electronic wireless communication with one or more data exchange infrastructure devices; and a virtual interface preprogrammed in the microprocessor with a protocol for seeking, detecting and establishing two-way data exchange communication with at least one data exchange infrastructure device.

The remote data processing and storage device may be also referred to herein as a belt-top. The belt-top may also include several preferential features. Such features may include a security arrangement to enhance data security. The security arrangement may include an arrangement for data encryption and decryption, an arrangement for data verification, or both. Further, the remote data processing and storage device may be configured to reject any incoming connection and to thereby initiate all data connections for data exchange. In addition, the remote data processing and storage device may be configured for operation in an environment including two or more remote data processing and storage devices. The remote data processing and storage device may also be configured to accept signals from multiple data exchange infrastructure devices. The remote data processing and storage device may also be configured to recognize predetermined data stream structures and encode the data stream for more efficient transmission. To that end, the remote data processing and storage device may interact with a programmable channel in a data exchange infrastructure device to encode the data stream for more efficient transmission.

Further, the remote data processing and storage device may be configured to define an execution environment to prevent access to any remote data processing and storage device resources except the data exchange stream and a predetermined amount of storage space. The remote data processing and storage device may be configured to insure that any received input information originated with an intended data exchange infrastructure device. The transmitter and receiver assembly may be configured for operation within variable, predetermined ranges.

According to another preferred embodiment thereof, the present data exchange infrastructure device for wireless, two-way data transfer communication with a remote data processing and storage device includes a housing; a power supply; a memory for data storage disposed within the housing and in electrical communication with the power supply; a transmitter and receiver assembly disposed within the housing and in electrical communication with the power supply for electronic wireless data exchange; an interface assembly in electrical communication with the power supply and disposed within the housing in electrical communication with the transmitter and receiver assembly, and preprogrammed for announcing a protocol directed to any remote data processing and storage devices within a predetermined range around the data exchange infrastructure device, being detected thereby and establishing two-way data exchange communication therewith.

It is preferred that the data exchange infrastructure device provide data exchange access for the remote data processing and storage device to an infrastructure device selected from a group consisting of equipment in the nature of a display, a keyboard, an audio device, a joystick, a haptic device, a tablet, and a mouse. The audio device may include speakers, microphones, or any other sound-generating or sound processing device. This list is not meant to be all-inclusive now and in the future. The present invention is useful with any device that can be used by a human to interact with a computer, now existing or in the future.

Preferably, the data exchange infrastructure device includes a security arrangement to enhance data security. The security arrangement may include an arrangement for data encryption and decryption, an arrangement for data verification, or both.

The data exchange infrastructure device may be configured for operation in an environment including two or more remote data processing and storage devices. Further, the data exchange infrastructure device may be configured to accept signals from multiple remote data processing and storage devices.

The data exchange infrastructure device also preferably includes a programmable channel for interaction with a remote data processing and storage device to encode the data stream for more efficient transmission. The data exchange infrastructure device may be configured to define an execution environment to prevent access to any data exchange infrastructure device resources except the data exchange stream and a predetermined amount of storage space. The data exchange infrastructure device may also be configured to direct data exchange signals from one or more remote data processing and storage devices among a plurality of infrastructure devices.

It is preferred that the data exchange infrastructure device be configured to recognize signal details associated with another infrastructure device and to process the details in order to present a uniform interface signal for use by a remote data processing and storage device.

The present invention also includes a system for remote data exchange and processing among computing devices, which includes remote data processing and storage devices and data exchange infrastructure devices operable in concert to provide a wireless computing environment. To that end, a system for remote data exchange and processing among computing devices includes at least one remote data processing and storage device for two-way, wireless communication with the one or more data exchange infrastructure devices, and one or more data exchange infrastructure devices. A remote data processing and storage device according to the present system includes a first housing; a first power supply disposed within the remote data processing and storage device housing; a first microprocessor in electrical communication with the first power supply and disposed within the first housing; a first data memory storage unit in electrical communication with the first power supply and disposed within the first housing; a first transmitter and receiver assembly in electrical communication with the power supply and disposed within the first housing for electronic two-way wireless communication with one or more data exchange infrastructure devices; and a virtual interface preprogrammed in the first microprocessor with a protocol for seeking, detecting and establishing two-way data exchange communication with at least one data exchange infrastructure device.

A data exchange infrastructure device according to the system of present system includes a second housing; a second power supply; a second memory for data storage disposed within the second housing and in electrical communication with the second power supply; a second transmitter and receiver assembly disposed within the housing and in electrical communication with the second power supply for electronic, two-way wireless data transfer; and an interface assembly in electrical communication with the power supply and disposed within the housing in electrical communication with the transmitter and receiver assembly, and preprogrammed for announcing its presence within a predetermined range using a protocol, being detected and establishing two-way data exchange communication.

The system preferably includes a number of features including a security arrangement to enhance data security. The security arrangement may include an arrangement for data encryption and decryption, an arrangement for data verification, or both.

Preferably, the remote data processing and storage device may be configured to reject any incoming connection and to thereby initiate all data connections for data exchange. Further, the remote data processing and storage device may be configured for operation in an environment including two or more remote data processing and storage devices. The remote data processing and storage device may also be configured to accept signals from multiple data exchange infrastructure devices. In addition, the remote data processing and storage device may be configured to recognize predetermined data stream structures and encode the data stream for more efficient transmission.

It is preferred that the data exchange infrastructure device include a programmable channel for interaction with a remote data processing and storage device to encode the data stream for more efficient transmission. It is also preferred that the remote data processing and storage device interact with the programmable channel in a data exchange infrastructure device to encode the data stream for more efficient transmission.

The remote data processing and storage device may be configured to define an execution environment to prevent access to any remote data processing and storage device resources except the data exchange stream and a predetermined amount of storage space. Further, the remote data processing and storage device may be configured to insure that any received input information originated with an intended data exchange infrastructure device. In addition, the transmitter and receiver assembly may be configured for operation within variable, predetermined displacements from any data exchange infrastructure devices.

It is preferred that the data exchange infrastructure device provide data exchange access for the remote data processing and storage device to an infrastructure device selected from a group consisting of equipment in the nature of a display, a keyboard, an audio device, a joystick, a haptic device, a tablet, and a mouse. The audio device may include speakers, microphones, or any other sound-generating or sound processing device. As stated elsewhere herein, the list is not meant to be all-inclusive now and in the future. The present invention is useful with any device that can be used by a human to interact with a computer, now existing or in the future.

Preferably, the remote data processing and storage device is configured for operation in an environment including two or more remote data processing and storage devices. The data exchange infrastructure device may be configured to define an execution environment to prevent access to any data exchange infrastructure device resources except the data exchange stream and a predetermined amount of storage space. The data exchange infrastructure device may also be configured to direct data exchange signals from one or more remote data processing and storage devices among a plurality of infrastructure devices.

The data exchange infrastructure device may be configured to recognize signal details associated with another infrastructure device and to process the details in order to present a uniform interface signal for use by a remote data processing and storage device.

The system of the present invention further may include a core data exchange infrastructure device for wireless, two-way data transfer communication with a dedicated remote data processing and storage device. The core device includes a housing; a power supply; a memory for data storage disposed within the housing and in electrical communication with the power supply; a processor for processing data and presenting the data for display; a transmitter and receiver assembly disposed within the housing and in electrical communication with the power supply for electronic wireless data exchange; a display for presenting data in a user recognizable format; and an interface preprogrammed within the processor for two-way data exchange communication with the remote data processing and storage device, the interface being in electrical communication with the display for presenting data from the remote data processing and storage device for a user.

Preferably, the core data exchange infrastructure device display includes a screen having a graphic user interface presented thereon. It is further preferred that the core data exchange infrastructure device be formed as a personal digital assistant.

The core device may exist outside the system. Accordingly, a core data exchange infrastructure device for wireless, two-way data transfer communication with a dedicated remote data processing and storage device includes a housing; a power supply; a memory for data storage disposed within the housing and in electrical communication with the power supply; a processor for processing data and presenting the data for display; a transmitter and receiver assembly disposed within the housing and in electrical communication with the power supply for electronic wireless data exchange; a display for presenting data in a user recognizable format; and an interface preprogrammed within the processor for two-way data exchange communication with the remote data processing and storage device, the interface being in electrical communication with the display for presenting data from the remote data processing and storage device for a user.

Preferably, the display includes a screen having a graphic user interface presented thereon. Further, the core device may be formed as a personal digital assistant.

The computer protocols and other programs are important to proper system operation. To that end, the computer protocols associated with the present system are described as a data signal, a computer program and a recordable media carrying the program.

The present invention also includes a computer data signal embodied in a carrier wave for interfacing remote computing devices with data exchange infrastructure devices. Such a data signal includes computer-executable instructions for seeking a protocol announcing the presence of one or more data exchange infrastructure devices; computer-executable instructions for detecting the protocol; and computer-executable instructions for establishing two-way data exchange communication with the at least one of the data exchange infrastructure devices.

Preferably the data signal includes computer-executable instructions for enhancing data security. Computer-executable instructions may be included for encrypting data. Further, computer-executable instructions may be included for data verification. Also included are computer-executable instructions defining a virtual interface protocol for seeking, detecting and establishing two-way data exchange communication with at least one data exchange infrastructure device.

Preferably, the data signal includes computer-executable instructions for recognizing predetermined data stream structures and to encode the data stream for more efficient transmission. In addition, computer-executable instructions may be provided for defining an execution environment to prevent access to any remote data processing and storage device resources except the data exchange stream and a predetermined amount of storage space. The computer data signal may also include computer-executable instructions for insuring that any received input information originated with an intended data exchange infrastructure device.

The computer protocol also can exist as a computer-readable media storing computer-executable instructions for interfacing remote computing devices with data exchange infrastructure devices. There, the computer-readable media includes computer-executable instructions for seeking a protocol announcing the presence of one or more data exchange infrastructure devices; computer-executable instructions for detecting the protocol; and computer-executable instructions for establishing two-way data exchange communication with the at least one of the one or more data exchange infrastructure devices.

Preferably the computer-readable media includes computer-executable instructions for enhancing data security. The computer-readable media may include computer-executable instructions for encrypting data. Further, computer-executable instructions may be included for data verification.

The media may further include computer-executable instructions defining a virtual interface protocol for seeking, detecting and establishing two-way data exchange communication with at least one data exchange infrastructure device, and computer-executable instructions for recognizing predetermined data stream structures and to encode the data stream for more efficient transmission.

The computer-readable media may preferably include computer-executable instructions for defining an execution environment to prevent access to any remote data processing and storage device resources except the data exchange stream and a predetermined amount of storage space. Additionally, the media may include computer-executable instructions for insuring that any received input information originated with an intended data exchange infrastructure device.

The protocol may also exist as a computer program. To that end, a computer program embodied on a computer-readable media for interfacing remote computing devices with data exchange infrastructure devices includes a code segment for seeking a protocol announcing the presence of one or more data exchange infrastructure devices; a code segment for detecting the protocol; and a code segment for establishing two-way data exchange communication with the at least one of the one or more data exchange infrastructure devices.

Preferably the program includes a code segment for enhancing data security. The program may also include a code segment for encrypting and decrypting data. Further, a code segment may be included for data verification.

The program may further include a code segment defining a virtual interface protocol for seeking, detecting and establishing two-way data exchange communication with at least one data exchange infrastructure device and a code segment for recognizing predetermined data stream structures and to encode the data stream for more efficient transmission.

Preferably the computer program includes a code segment defining an execution environment to prevent access to any remote data processing and storage device resources except the data exchange stream and a predetermined amount of storage space. A code segment may also be provided for insuring that any received input information originated with an intended data exchange infrastructure device.

The computer protocol also exists in a form usable by the data exchange infrastructure devices. To that end, computer data signal embodied in a carrier wave for interfacing data exchange infrastructure devices with remote data processing and storage devices includes computer-executable instructions for announcing a protocol directed to any remote data processing and storage devices within a predetermined range around the data exchange infrastructure device; computer-executable instructions for being detected by remote data processing and storage devices; and computer-executable instructions for establishing two-way data exchange communication with the remote data processing and storage devices.

Preferably, the data signal includes computer-executable instructions for enhancing data security. The data signal may also include computer-executable instructions for encrypting data. Further, computer-executable instructions may be included for data verification.

Preferably, the computer data signal also includes computer-executable instructions for discriminating between signals from multiple remote data processing and storage devices, and for preventing access to any data exchange infrastructure device resources except the data exchange stream and a predetermined amount of storage space. Also computer-executable instructions may be included for directing data exchange signals from one or more remote data processing and storage devices among a plurality of infrastructure devices.

The computer data signal may further include computer-executable instructions for recognizing signal details associated with an infrastructure device and to process the details in order to present a uniform interface signal for use by a remote data processing and storage device.

The protocol may also exist as a computer-readable media storing computer-executable instructions for interfacing data exchange infrastructure devices with remote data processing and storage devices carrying computer-executable instructions for announcing a protocol directed to any remote data processing and storage devices within a predetermined range around the data exchange infrastructure device; computer-executable instructions for being detected by remote data processing and storage devices; and computer-executable instructions for establishing two-way data exchange communication with the remote data processing and storage devices.

Preferably, the computer-readable media includes computer-executable instructions for enhancing data security. The computer-readable media may include computer-executable instructions for encrypting data. Further, computer-executable instructions may be included for data verification.

It is preferential that the computer-readable media further includes computer-executable instructions for discriminating between signals from multiple remote data processing and storage devices, and for preventing access to any data exchange infrastructure device resources except the data exchange stream and a predetermined amount of storage space.

The media may further carry computer-executable instructions for directing data exchange signals from one or more remote data processing and storage devices among a plurality of infrastructure devices. Additionally, the media may carry computer-executable instructions for recognizing signal details associated with an infrastructure device and to process the details in order to present a uniform interface signal for use by a remote data processing and storage device.

The present invention also includes a computer program embodied on a computer-readable media for interfacing data exchange infrastructure devices with remote data processing and storage devices having a code segment for announcing a protocol directed to any remote data processing and storage devices within a predetermined range around the data exchange infrastructure device; a code segment for being detected by remote data processing and storage devices; and a code segment for establishing two-way data exchange communication with the remote data processing and storage devices.

Preferably, the program includes a code segment for enhancing data security. The program may include a code segment for encrypting data. Further, a code segment may be included for data verification.

It is preferred that the program includes a code segment for discriminating between signals from multiple remote data processing and storage devices, and for preventing access to any data exchange infrastructure device resources except the data exchange stream and a predetermined amount of storage space.

It is further preferred that the program include a code segment for directing data exchange signals from one or more remote data processing and storage devices among a plurality of infrastructure devices. The program preferably includes a code segment defining instructions for recognizing signal details associated with an infrastructure device and to process the details in order to present a uniform interface signal for use by a remote data processing and storage device.

The present invention also includes methods of commercially utilizing the system of the present invention. The commercial use may involve sales of data products, sales of transmission channel usage, or computer usage time. Commercial use may also be made of the ability of the system to perform data verification services.

A first method includes a method for commercially facilitating data use, exchange and processing comprising the steps of:
(1) providing at least one remote data processing and storage device for wireless data exchange, the remote data processing and storage device including a transmitter and receiver assembly, a microprocessor and a virtual interface preprogrammed in the microprocessor with a protocol for seeking, detecting and establishing two-way data exchange communication with at least one data exchange infrastructure device;
(2) providing at least one data exchange infrastructure device for wireless data exchange with the at least one remote data processing and storage device including a transmitter and receiver assembly and an interface assembly in electrical communication with the transmitter and receiver assembly, and preprogrammed for announcing a protocol directed to any remote data processing and storage devices within a predetermined range around the data exchange infrastructure device, being detected thereby and establishing two-way data exchange communication therewith;
(3) charging a fee for users of the at least one remote data processing and storage device using the at least one data exchange infrastructure device.

Preferably, the method may further include the step of providing a core data exchange infrastructure device for wireless, two-way data transfer communication with a dedicated remote data processing and storage device, with the core data exchange infrastructure device including a processor for processing data and presenting the data for display; a transmitter and receiver assembly disposed within the housing and in electrical communication with the power supply for electronic wireless data exchange; a display for presenting data in a user recognizable format and an interface preprogrammed within the processor for two-way data exchange communication with the remote data processing and storage device, the interface being in electrical communication with the display for presenting data from the remote data processing and storage device for a user.

The method may preferentially further include the step of using at least one data exchange infrastructure device to coordinate and direct data signals among predetermined data exchange infrastructure devices and remote data processing and storage devices. In addition, the method may include the step of providing at least one data exchange infrastructure device configured to meter transmission channel usage and to allocate system resources in accordance with the metered transmission channel usage.

It is preferred that the method include the steps of conducting a commercial sales transaction using at least one data exchange device and at least one remote data processing and storage device; establishing a two-way data exchange; delivering a data product to a buyer using the two-way data exchange; and charging the buyer for the data product. Further, the step of charging the buyer may include transferring payment using the two-way data exchange.

Preferably, the method includes the step of providing a security arrangement operatively associated with said data exchange infrastructure device. Further, the step of providing a security arrangement includes providing a data verification arrangement. The method may also include the step of charging a fee for utilization of said data verification arrangement.

Another preferred method for the present invention is a method for facilitating commercial sales transactions of data products comprising the steps of:
(1) providing at least one remote data processing and storage device for wireless data exchange, the remote data processing and storage device including a transmitter and receiver assembly, a microprocessor and a virtual interface preprogrammed in the microprocessor with a protocol for seeking, detecting and establishing two-way data exchange communication with at least one data exchange infrastructure device;
(2) providing at least one data exchange infrastructure device for wireless data exchange with the at least one remote data processing and storage device including a transmitter and receiver assembly and an interface assembly in electrical communication with the transmitter and receiver assembly, and preprogrammed for announcing a protocol directed to any remote data processing and storage devices within a predetermined range around the data exchange infrastructure device, being detected thereby and establishing two-way data exchange communication therewith;
(3) transferring a data product to a buyer using the two-way data exchange; and
(4) charging buyers for any data products obtained during two-way data exchange.

Preferably, the method for facilitating commercial sales transactions of data products further includes the step of providing a core data exchange infrastructure device for wireless, two-way data transfer communication with a dedicated remote data processing and storage device, the core data exchange infrastructure device including a processor for processing data and presenting the data for display; a transmitter and receiver assembly disposed within the housing and in electrical communication with the power supply for electronic wireless data exchange; a display for presenting data in a user recognizable format and an interface preprogrammed within the processor for two-way data exchange communication with the remote data processing and storage device, the interface being in electrical communication with the display for presenting data from the remote data processing and storage device for a buyer.

It is preferred that the method for facilitating commercial sales transactions of data products further includes the step of using at least one data exchange infrastructure device to coordinate and direct data signals among predetermined data exchange infrastructure devices configured for distribution of data products and remote data processing and storage devices. Further, the step of charging the buyer may include transferring payment using the two-way data exchange.

Preferably, the method includes the step of providing a security arrangement operatively associated with said data exchange infrastructure device. It is preferred that the step of providing a security arrangement includes providing a data verification arrangement. Preferably, the method includes charging a fee for utilization of said data verification arrangement.

By the above, the present invention provides a system of remote data processing and storage devices operable in concert with a data exchange infrastructure populated with such infrastructure devices as a keyboard, mouse and display as well as a controller to manage data traffic in and out of the infrastructure. The ability to miniaturize components is enhanced by the separation of user interfaces from the data processing and storage devices. Commerce is enhanced as well, by the ability of the system to provide remote data access and storage which can assist in commercial transactions for data products and for computer time.

### BRIEF DESCRIPTION OF THE DRAWINGS

FIG. 1 is a diagrammatic view of a system for remote data processing and storage according to a preferred embodiment of the present invention;

FIG. 2 is diagrammatic view of the system of FIG. 1 illustrating data output;

FIG. 3 is a diagrammatic view of the system of FIG. 1 illustrating data input;

FIG. 4 is an elevational view of a core device; and

FIG. 5 is an elevational view of the core device in FIG. 4 connected with a system for remote data processing and storage as illustrated in FIG. 1.

### DESCRIPTION OF THE PREFERRED EMBODIMENTS

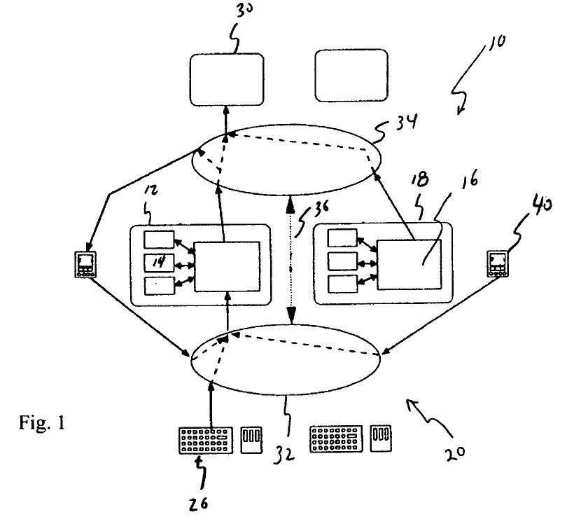

Turning now to the drawings and, more particularly to FIG. 1, a system for remote data exchange and processing is illustrated generally at 10 and includes two fundamental hardware components. These include a remote data and processing storage device 12, 18 and one or more data exchange infrastructure devices forming a data exchange infrastructure 20. These two central elements form the foundation of the system data exchange and processing. One basic function of the present invention is to provide a remote data processing and storage device that may be handheld for communication with remotely located interface devices, e.g., a keyboard, mouse and display, all part of the data exchange infrastructure 20.

An additional component of the system, although not an absolute requirement, is a core infrastructure device illustrated at 40 in FIG. 1. The core infrastructure device 40, also referred to herein as a core device provides a handheld device that presents the initial graphic user interface (GUI) to allow a user of the remote data processing and storage device 12,18, also referred to herein as a belt-top, to access a mobile connection service 32, 34 that is part of the data exchange infrastructure 20, controls the allocation of resources and directs operation of the data exchange infrastructure devices within the system.

The controller portion of the data exchange infrastructure 20, which may be made up of several data exchange infrastructure devices, includes a mobile input connection service 32 and a mobile output connection service 34 that are interconnected by a control channel 36. The mobile connection service 32, 34 of the data exchange infrastructure 20 controls several devices for human interaction with computerized data including a keyboard 26 and a display 30 as illustrated in FIG. 1.

The term “belt-top” is used to represent the remote data processing and storage devices 12,18 with the term being chosen to reflect the small size and mobility of the devices. Due to the separation of human interfaces from the data processing and storage device, the belt-top can be miniaturized beyond what has been previously accomplished with computers. It is expected that the belt-top will take many forms yet will still provide such fundamental structure as a housing, power supply, microprocessor and memory storage. A transmitter and receiver assembly should also be provided to allow the device to communicate with the remainder of the system.

The belt-top 12 of the present invention is represented herein diagramatically. Nevertheless, the physical structure of the belt-top 12 is well within the skill of those of ordinary skill in the computer manufacturing arts, even though it is a heretofore-unknown device. The outer appearance of the belt-top 12 is of little concern to the functionality of the device in the system. It may take many forms, and with ongoing miniaturization efforts, the belt-top 12 will likely take smaller housings in the future.

In order for the belt-top 12 to communicate with the data infrastructure 20, a virtual interface is programmed in the microprocessor of the belt-top 12. This virtual interface allows a user to communicate with the data exchange infrastructure devices without physical interaction with belt-top components. The virtual interface also operates and coexists with a security arrangement that is programmed to maintain the security of data exchanges with the infrastructure devices. The belt-tops 12,18 are also programmed for several other features that will be described in greater detail hereinafter. The usefulness of the belt-tops and of the entire system will be more fully appreciated once the operation, including commercial operation is set forth.

A belt-top 12 includes a window server 16 that interacts with preprogrammed applications 14, as seen in FIG. 1, which includes the virtual interface and the security programming. Whereas the belt-tops 12,18 provide computing power and storage space, the data exchange infrastructure 20 provides the necessary tools for human interaction with the belt-tops 12, 18. During any data exchange, there will be input to and output from a belt-top 12 and, accordingly, the data exchange infrastructure 20 includes the mobile input connection service 32 and the mobile output connection service 34, interlinked with a common control channel 26.

The data exchange infrastructure 20 typically operates in a system environment having multiple belt-tops and must therefore distinguish among belt-tops and coordinate the data traffic coming in and out of the system. Such processes require coordinated resource sharing in order to maintain system integrity, data integrity and to provide a reasonable response time. Sharing resources will be discussed in greater detail hereinafter.

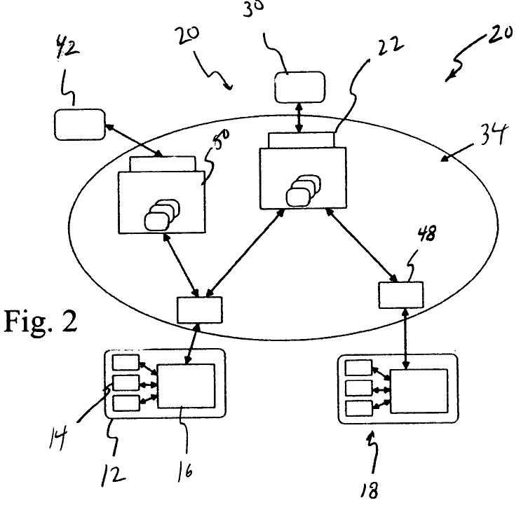

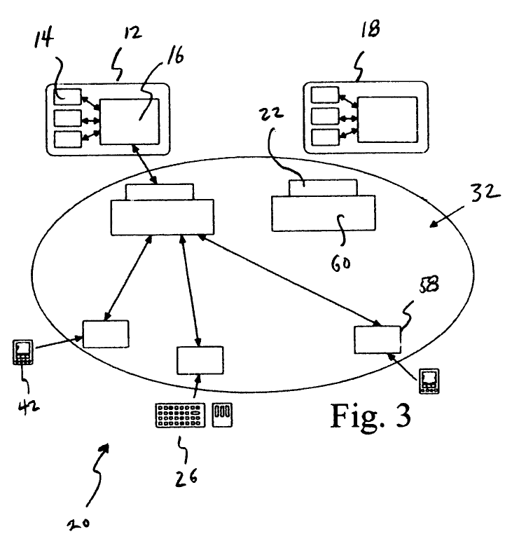

The mobile service 32, 34 of the present invention each include a virtualizing device 50, 60 and a director 48, 58, as seen in FIGS. 2 and 3. The purpose of the directors, i.e., the output director 48 and the input director 58, is to redirect data to the appropriate virtualizing device, either the output virtualizing device 50 or the input virtualizing device 60, based on the then-current sharing model.

The mobile service 32, 34 provides several functions. It will locate and identify data exchange infrastructure devices such as the keyboard 26 and display 30. It will establish trusted and authenticated connections between a belt-top and the desired interface infrastructure device(s). It will enforce the sharing model access and control policies for resource allocation. It will dynamically direct input to the appropriate belt-top and output to the appropriate display or other infrastructure device in order to achieve the desired sharing and collaboration among users. The infrastructure devices can be configured for individual use in a sharing situation or two or more belt-top operators may conduct their data business together, in a collaboration setting.

The mobile service 32, 34 also efficiently transfers data to and from the belt-tops 12,18. FIG. 1 illustrates two belt-top users working together on a shared display infrastructure. The shared display is illustrated at 30. The arrows indicate data traffic routing patterns to achieve this result. The framework illustrated in FIG. 1 enables a number of interactions between the computing environment and the input output infrastructure devices.

For example, upon entering an office, a second user's belt-top can cause the mobile service to discover and negotiate secure access to the first user's display. The second user is able to use the first user's display by redirecting output from the second user's belt-top to the display and redirecting input from a portable PDA, functioning as a core device 40, to control the belt-top environment. The mobile service knows about the first user's environment as well and can also manage the two environments simultaneously on the same physical display, allowing input from one user to be directed to the environment of the other. This is a collaboration environment made possible by the present invention.

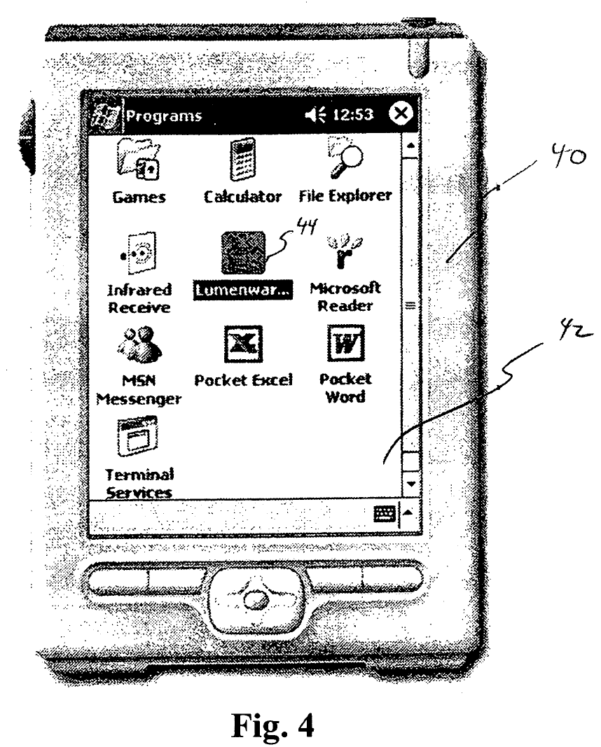

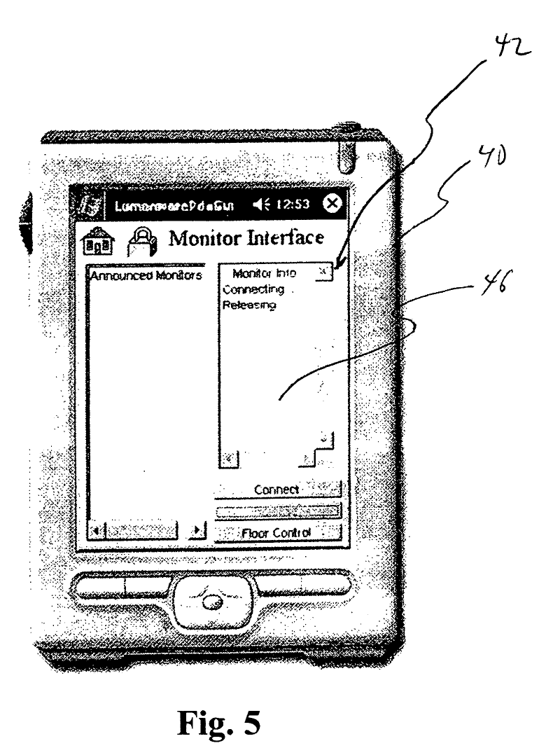

The present invention also includes the aforementioned core infrastructure device 40 which, in this situation, is illustrated in FIGS. 4 and 5 as a personal digital assistant (PDA). In order to provide the belt-top user with initial control over the data exchange infrastructure 20, the present invention provides the core device 40 to initially interact with the belt-top 12 in order to establish communication between the data exchange infrastructure 20 and the user's belt-top 12. The core device 40 may also take on any form within the confines of its stated function to provide the initial interface for linking a belt-top with the mobile system. As seen in FIG. 4, the GUI of a conventional PDA 40 is illustrated at 42. An icon 44 is provided for executing the program required to establish communication with the belt-top 12.

As seen in FIG. 5, execution of the belt-top acquisition program provides another graphic user interface 46 which is illustrated as a display interface and acts as a map to the data exchange infrastructure.

It should be noted that the data exchange infrastructure devices available for possible access by the belt-top are numerous and include an array of equipment in the nature of a display, a keyboard, an audio device, a joystick, a haptick device, a tablet, and a mouse. The audio device may include speakers, microphones, or any other sound-generating or sound processing device. All of the foregoing devices have as a fundamental element of their nature the ability to provide an interface for humans to interact with computers. Therefore, the term infrastructure device should not be limited in any way to the preceding list and should encompass any device now or in the future that will allow a human being to interact with a computer.

In order to coordinate the operation of the system for dynamically and seamlessly connecting a user's belt-top to appropriate data exchange infrastructure devices both communication and sharing applications are required. The sharing applications support a level of sharing and multiplexing that goes beyond the current state-of-the-art. The sharing model multiplexes multiple independent windowing systems together according to specific preferences and contexts.

The sharing applications of the present invention are based on four independent sharing models. The models may be used separately or simultaneously. The sharing models are discussed in terms of multiplexing.

The first and most straightforward sharing model is for the virtualizing output device to shift quickly and transparently among multiple users who wish to use the display in sequence. This is a time multiplexing model. The time scale of which the virtualizing output device changes from one user to another can vary. This model removes the requirement that display connections be manually configured between clients and the display device each time a new client wishes to make use of the display. Time multiplexing provides simple and transparent time sequential display sharing. Access and control policies, described in greater detail hereinafter, allow users to obtain exclusive sequential time multiplexing access for long time scale sharing or concurrent random multiplexing access, such as short time scale sharing in which users frequently switch between computing systems. Exclusive access is suited for use with display infrastructure in public locations such as kiosks, libraries, classrooms, airports and hotel rooms. Concurrent access is useful for collaborative work such as business meetings, and formal office meetings or playing multi-participant games.

Another form of display sharing is pixel space multiplexing, also referred to as space multiplexing. Here, the display area is dynamically partitioned and allocated to users. The allocated area may change over time. One feature of this model is that collaboration becomes possible when multiple computing environments are visible simultaneously. The juxtaposition of applications is accepted within a desktop computing system such as when two browser windows are being shown at the same time. Space multiplexing allows the display server to position multiple clients onto the available display pixels so that both environments are completely or partially visible at the same time. Space multiplexing will enable multiple users to work collaboratively on a single display, where they can compare display environments side-by-side as a document is developed.

Control multiplexing requires multiplexing input streams from multiple clients and is necessary to support collaborative operation where two or more users share control of one or more computing systems. For example, when two users are collaborating by spatially sharing the display, a first user may desire to move his or her mouse into the region of the display representing the other system and begin to control a second user's application. In a manner similar to time multiplexing, the first user's computing system might exclusively own the display and the second user may simply want to interact with those applications present. As will be discussed in greater detail hereinafter, access policies play a key role in control multiplexing.

Semantic multiplexing is the highest level multiplexing and requires semantic information about what is being displayed and who is in control of each semantic component. Semantic multiplexing allows for higher level sharing such as sharing individual windows, files and clipboards. A high level of semantic agreement between client and server can also promote efficiency and data transmission. However, semantic sharing requires semantic knowledge about the computing system's input and output which will differ from system to system. As a result interoperability between the systems is not guaranteed as it is with the sharing models as discussed previously.

Access and control policies are needed to prohibit unauthorized use of potentially shared resources. Moreover, access and control policies may need to be changed on-the-fly, i.e., during active use. For example, User A might initially prohibit all other users from controlling its applications and windowing environment, but when User B walks into the office to collaborate, User A may decide to grant User B access. It is fundamental that each computing system be able to control access to its own resources, e.g., access to its output for display and to its input for data input. Both the virtualizing input device and the virtualizing output device enforce application-specific access policies. The window server uses a control protocol to maintain the user's access policies. For example, the input access policy may be configured to allow random users to manipulate their own cursor in a region of the screen that is not their own, e.g. to point out certain things on the screen, but disallows them from entering mouse clicks or keyboard events that would interact with the first users applications.

Also included within the necessary programming or protocols, and discussed below are the necessary security arrangements. It is contemplated that a system similar to the present system could be constructed that is completely free of any security arrangements whatsoever and would still come within the scope of the present invention. Therefore, the security arrangements can be seen as enhancements to the basic structure of the present invention and enhancements that make the commercial viability of the present invention more realistic. This commercial viability refers to the ability of the present invention to conduct and manage commercial transactions. The present system could be used in a home or private environment completely devoid of security arrangements without departing from the present invention. Nevertheless, even though theoretically possible, such a system may find little practical use.

The security arrangements include arrangements for encrypting and decrypting data. Encryption generally refers to encryption prior to data transmission and decryption includes decryption after data reception. Data verification includes protecting data integrity prior to transmission and verifying the authenticity of received data.

The protocols of the present invention are set forth elsewhere herein as a computer data signal, a computer program, and a computer readable medium. This is intended to cover whatever forms in which the instant protocols may exist from time to time and is not intended to limit the form in which the protocols may exist, now or in the future.

In order to initiate communications within the system of belt-tops and infrastructure devices, and in order to utilize the separable user interface architecture, an announcement protocol is provided and is emitted from the data exchange infrastructure. The announcement protocol can be received by a user's belt-top. The user can then act to establish two-way communication with the data exchange infrastructure and conduct whatever computing business is at hand.

The data exchange infrastructure abstracts the details of the specific infrastructure devices, i.e. keyboards, mice, et al., that may arise in practice and offers a uniform interface to a user's belt-top. The mobile service of the data exchange infrastructure implements a communication protocol used to connect a device and acts as the manager for the device, establishing and enforcing the sharing policy by controlling who can simultaneously share a given device and how that sharing is accomplished. By abstracting the interface that manages the device and enforcing the sharing rules and policies, belt-tops can use the same methods to access, control and share all types of infrastructure devices.

As part of the security protocol, the belt-top is configured to reject any incoming connection commands and to initiate all data connections for data exchange. Since the belt-top acts as a primary repository of the user's mobile data, the user has control over data movement in and out of the belt-top.

The belt-top protocol can also provide a floor control service or floor controller. The floor controller can direct and redirect a belt-top input and output on-the-fly to any desired infrastructure device, thereby coordinating data transfer. For example, users can move their desktop from one display to another display just by clicking on an infrastructure device selected from a list of those available as depicted in the core device. The floor controller service can also be used to arbitrate between belt-tops trying to access the same infrastructure device.

The separable user interface of the present invention is enabled by a secure software-based network access protocol that replaces conventional hardware-based physical user interface connections with a flexible software-based system forming the virtual interface of the belt-top and the sharing and control functions of the infrastructure devices. The infrastructure devices are provided with a program that will announce a protocol directed to any belt-tops that might be within a predetermined range around the system. As may be expected, the belt-tops include a computer program that seeks the announcing protocol and, once it is found, responds thereto. The IFD protocol is configured for such detection and once the detection occurs, a handshake protocol is provided and communications between the belt-tops and the data exchange infrastructure is established.

As discussed above, security protocols are also included within the system of the present invention. The security features include a data encryption arrangement and a data verification arrangement. In furtherance of system security, the protocol can provide access to any infrastructure device except the data exchange stream and a predetermined amount of storage space thereby limiting a belt-top users access. Alternately, it can provide wide access and sharing of resources dependent upon the mode in which the system is operational at any given time. The protocol will also allow data exchange signals to be directed from one or more remote data processing and storage devices among a plurality of infrastructure devices. For example, a user may be engaged with both a mouse and a display while the system selects among the devices as needed.

One feature of the protocol is its ability to recognize data signals associated with a certain infrastructure device and to process those signal details in order to present a uniform interface signal for use by the belt-top.

With respect to the belt-top, the present invention provides a virtual interface protocol for seeking, detecting and establishing two way data communication with the data exchange infrastructure as described above. It also can recognize a predetermined data stream structure and encode that particular data stream in a manner that provides more efficient data transmission. Interference from other computers may be eliminated by the protocol insuring that any received input information has originated with an intended infrastructure device.

As seen in FIGS. 2 and 3, output and input directors are provided and illustrated at 48 and 58 respectively. The function of the directors 48, 58 is to redirect incoming data either from an input device or from the computing systems window server, to the appropriate virtualizing device 50, 60 based on the current sharing model. Access policies are illustrated generally at 22 for controlling operation of the appropriate virtualizing device(s) 50, 60 based on then-prevailing policies and protocols.

As an example, consider user A and user B collaborating with both spatial and controlling multiplex activity. The shared display shows User A's environment on one side of the screen and user B's on the other. Initially, both User A and User B work on their own side of the display but then User B moves his or her cursor onto User A's side. Unfortunately, because the shared display is actually composed from the output of two or more independently generated window systems, it is difficult to correlate mouse movement with the coordinate positions of the display system. In order for User B to move about in User A's space and gain control over User A's application, the input mobile service needs to inform User B's input director to redirect future input to User A's virtualizing input device. To make this possible, the virtualizing output device which manages the display space allocation periodically informs the window server and the virtualizing input device discovers that User B has moved on to the edge of its window. It consults the information previously broadcast by the virtualizing output device to identify the computing system that controls the adjacent display space. User B's virtualizing input device then issues a control message to User B's input director to ask that it redirect input to User A's virtualizing input device. User B can then move about in User A's space in control application. When User B moves back toward its own space, User A's virtualizing input device for request User B's input director to redirect input to User B's virtualizing input device.

The virtualizing device provides a multi-user device abstraction. The virtualizing device multiplexes several input sources together to form a single combined display and to collectively control applications. For example, the virtualizing input device can multiplex three mice together. The sharing model might cause the three to appear as a single mouse allowing any of the mouse control inputs to control a single cursor or the sharing model might cause each mouse to control its own cursor. Similarly, the virtual output device multiplexes multiple displays onto a single display.

From the above, it is seen that a system that provides access to common interface devices can be used with remote data processing and storage devices to provide user access for one or more belt-top users on a selective basis to the various infrastructure devices.

The foregoing system has many commercial possibilities. The system may provide a basic commercial setting in which fees are charged for the use of various infrastructure devices. For example, a belt-top user may decide to modify data that is on the belt-top that has been previously modified from a home computer. In a commercial setting, the belt-top user would enter an establishment and have belt-top encounter the announcing protocol of the data exchange infrastructure. Using a core device, two-way communication would then be established between the core device and the infrastructure by system floor controller. Once the two-way data exchange communication is established, the user can select keyboards, mice, displays, or other devices as necessary to complete a task. Once the data is modified to the extent required by the user, the data may be stored on the belt-top memory.

The system of the present invention also may be used for commercial sales of data products. Such data products may include applications software, games, music, movies or other entertainment-based data. In that situation, a fee would be charged for the products and a supplemental fee may be charged for access. In this scenario, the belt-top would communicate with a server that provided digital products. The digital products would be downloaded onto the belt-top and a fee could be charged to the user.

Another commercial situation utilizing the system of the present invention would be a game playing environment wherein video game enthusiasts enter a data exchange infrastructure space and collaborate using the sharing protocols in order to play games. Scores would be stored on belt-tops and then saved or reused.

Another commercial situation is the nature of the Internet café or an Internet room on cruise ships. This is a variation of the first system discussed herein and provides for charging shipboard passengers or café patrons a fee for use of the system. The shipboard passengers could write e-mails and send the e-mails from the cruise ships Internet room and retain the e-mail data on their own belt-top. A fee could be charged for this use. Further, given the security enhancements of the present invention, the present invention could be used to provide verification of data for a fee.

Based on the above, it can be seen that the present invention provides multiple key benefits for computer users and developers. Since the present invention provides separable user interfaces, computer and interface devices can evolve separately and independently, without constraining one another. Ever shrinking computer systems will need only a virtual interface to take advantage of a wide array of user interface devices, from room microphones to plasma screens as well as any heretofore-unknown interface devices. Further, large-scale projector or flat screen based displays can be deployed as public infrastructure and used as needed by personal computer users that take their belt-tops wherever they go. Powerful applications may be run without being hamstrung by the interface of conventional computing devices. Third, new models of sharing and collaboration are enabled by the concept of displays as shared infrastructures. For example, multiple users may be sharing a large-scale display with each controlling a separate portion of the screen.

The environment has been created in which people may carry or wear miniature computer systems with substantial computing power and storage capability. The belt-top systems contain a user's personal computing environment. They have no integrated input display devices, instead relying on external hardware for most of the user's interface tasks. The user's computing environment interacts with a nearby infrastructure over wireless channels to discover and inform the user of available interface devices and then set up more secure communication channels to give the illusion of a directly connected device.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

1. A remote data processing and storage device for wireless, two-way data transfer communication with one or more data exchange infrastructure devices comprising;
a housing;
a power supply disposed within said housing;
a microprocessor in electrical communication with said power supply and disposed within said housing;
a data memory storage unit in electrical communication with said power supply and disposed within said housing;
a transmitter and receiver assembly in electrical communication with said microprocessor and said power supply, said transmitter and receiver assembly being disposed within said housing for electronic wireless communication with one or more data exchange infrastructure devices; and
a virtual interface preprogrammed in said microprocessor with a protocol for seeking, detecting and establishing two-way data exchange communication with at least one data exchange infrastructure device.

2. A remote data processing and storage device according to claim 1 and further comprising a security arrangement to enhance data security.

3. A remote data processing and storage device according to claim 2 wherein said a security arrangement includes a data encrypting and decrypting arrangement.

4. A remote data processing and storage device according to claim 2 wherein said security arrangement includes a data verification arrangement.

5. A remote data processing and storage device according to claim 1 wherein said remote data processing and storage device is configured to reject any incoming connection and to thereby initiate all data connections for data exchange.

6. A remote data processing and storage device according to claim 1 wherein said remote data processing and storage device is configured for operation in an environment including two or more remote data processing and storage devices.

7. A remote data processing and storage device according to claim 1 wherein said remote data processing and storage device is configured to accept signals from multiple data exchange infrastructure devices.

8. A remote data processing and storage device according to claim 1 wherein said remote data processing and storage device is configured to recognize predetermined data stream structures and encode the data stream for more efficient transmission.

9. A remote data processing and storage device according to claim 8 wherein said remote data processing and storage device interacts with a programmable channel in a data exchange infrastructure device to encode the data stream for more efficient transmission.

10. A remote data processing and storage device according to claim 1 wherein said remote data processing and storage device is configured to define an execution environment to prevent access to any remote data processing and storage device resources except the data exchange stream and a predetermined amount of storage space.

11. A remote data processing and storage device according to claim 1 wherein said remote data processing and storage device is configured to insure that any received input information originated with an intended data exchange infrastructure device.

12. A remote data processing and storage device according to claim 1 wherein said transmitter and receiver assembly is configured for operation within variable, predetermined ranges.

13. A data exchange infrastructure device for wireless, two-way data transfer communication with a remote data processing and storage device comprising:
a housing;
a power supply;
a memory for data storage disposed within said housing and in electrical communication with said power supply;
a transmitter and receiver assembly disposed within said housing and in electrical communication with said power supply for electronic wireless data exchange;
an interface assembly in electrical communication with said power supply and disposed within said housing in electrical communication with said transmitter and receiver assembly, and preprogrammed for announcing a protocol directed to any remote data processing and storage devices within a predetermined range around said data exchange infrastructure device, being detected thereby and establishing two-way data exchange communication therewith.

14. A data exchange infrastructure device according to claim 13 wherein said data exchange infrastructure device provides data exchange access for said remote data processing and storage device to an infrastructure device selected from a group consisting of equipment in the nature of a display, a keyboard, an audio device, a joystick, a haptic device, a tablet, and a mouse.

15. A data exchange infrastructure device according to claim 13 and further comprising a security arrangement to enhance data security.

16. A data exchange infrastructure device according to claim 15 wherein said security arrangement includes an arrangement for data encryption and decryption.

17. A data exchange infrastructure device according to claim 15 wherein said security arrangement includes an arrangement for data verification.

18. A data exchange infrastructure device according to claim 13 wherein said data exchange infrastructure device is configured for operation in an environment including two or more remote data processing and storage devices.

19. A data exchange infrastructure device according to claim 13 wherein said data exchange infrastructure device is configured to accept signals from multiple remote data processing and storage devices.

20. A data exchange infrastructure device according to claim 13 wherein said data exchange infrastructure device includes a programmable channel for interaction with a remote data processing and storage device to encode the data stream for more efficient transmission.

21. A data exchange infrastructure device according to claim 13 wherein said data exchange infrastructure device is configured to define an execution environment to prevent access to any data exchange infrastructure device resources except the data exchange stream and a predetermined amount of storage space.

22. A data exchange infrastructure device according to claim 13 wherein said data exchange infrastructure device is configured to direct data exchange signals from one or more remote data processing and storage devices among a plurality of infrastructure devices.

23. A data exchange infrastructure device according to claim 13 wherein said data exchange infrastructure device is configured to recognize signal details associated with an infrastructure device and to process said details in order to present a uniform interface signal for use by a remote data processing and storage device.

24. A system for remote data exchange and processing among computing devices comprising:
at least one remote data processing and storage device for two-way, wireless communication with said one or more data exchange infrastructure devices including;
a first housing;
a first power supply disposed within said remote data processing and storage device housing;
a first microprocessor in electrical communication with said first power supply and disposed within said first housing;
a first data memory storage unit in electrical communication with said first power supply and disposed within said first housing;
a first transmitter and receiver assembly in electrical communication with said power supply and disposed within said first housing for electronic two-way wireless communication with one or more data exchange infrastructure devices; and
a virtual interface preprogrammed in said first microprocessor with a protocol for seeking, detecting and establishing two-way data exchange communication with at least one data exchange infrastructure device; and
one or more data exchange infrastructure devices, each said data exchange infrastructure device including;
a second housing;
a second power supply;
a second memory for data storage disposed within said second housing and in electrical communication with said second power supply;
a second transmitter and receiver assembly disposed within said housing and in electrical communication with said second power supply for electronic, two-way wireless data transfer; and
an interface assembly in electrical communication with said power supply and disposed within said housing in electrical communication with said transmitter and receiver assembly, and preprogrammed for announcing its presence within a predetermined range using a protocol, being detected and establishing two-way data exchange communication.

25. A system for remote data exchange and processing among computing devices according to claim 24 and further comprising a security arrangement to enhance data security.

26. A system for remote data exchange and processing among computing devices according to claim 25 wherein said security arrangement includes an arrangement for data encryption and decryption.

27. A system for remote data exchange and processing among computing devices according to claim 24 wherein said security arrangement includes an arrangement for data verification.

28. A system for remote data exchange and processing among computing devices according to claim 24 wherein said remote data processing and storage device is configured to reject any incoming connection and to thereby initiate all data connections for data exchange.

29. A system for remote data exchange and processing among computing devices according to claim 24 wherein said remote data processing and storage device is configured for operation in an environment including two or more remote data processing and storage devices.

30. A system for remote data exchange and processing among computing devices according to claim 24 wherein said remote data processing and storage device is configured to accept signals from multiple data exchange infrastructure devices.

31. A system for remote data exchange and processing among computing devices according to claim 24 wherein said remote data processing and storage device is configured to recognize predetermined data stream structures and encode the data stream for more efficient transmission.

32. A system for remote data exchange and processing among computing devices according to claim 24 wherein said data exchange infrastructure device includes a programmable channel for interaction with a remote data processing and storage device to encode the data stream for more efficient transmission.

33. A system for remote data exchange and processing among computing devices according to claim 32 wherein said remote data processing and storage device interacts with said programmable channel in a data exchange infrastructure device to encode the data stream for more efficient transmission.

34. A system for remote data exchange and processing among computing devices according to claim 24 wherein said remote data processing and storage device is configured to define an execution environment to prevent access to any remote data processing and storage device resources except the data exchange stream and a predetermined amount of storage space.

35. A system for remote data exchange and processing among computing devices according to claim 24 wherein said remote data processing and storage device is configured to insure that any received input information originated with an intended data exchange infrastructure device.

36. A system for remote data exchange and processing among computing devices according to claim 24 wherein said transmitter and receiver assembly is configured for operation within variable, predetermined displacements from any data exchange infrastructure devices.

37. A system for remote data exchange and processing among computing devices according to claim 24 wherein said data exchange infrastructure device provides data exchange access for said remote data processing and storage device to an infrastructure device selected from a group consisting of equipment in the nature of a display, a keyboard, an audio device, a joystick, a haptic device, a tablet, and a mouse.

38. A system for remote data exchange and processing among computing devices according to claim 24 wherein said remote data processing and storage device is configured for operation in an environment including two or more remote data processing and storage devices.

39. A system for remote data exchange and processing among computing devices according to claim 24 wherein said data exchange infrastructure device is configured to define an execution environment to prevent access to any data exchange infrastructure device resources except the data exchange stream and a predetermined amount of storage space.

40. A system for remote data exchange and processing among computing devices according to claim 24 wherein said data exchange infrastructure device is configured to direct data exchange signals from one or more remote data processing and storage devices among a plurality of infrastructure devices.

41. A system for remote data exchange and processing among computing devices according to claim 24 wherein said data exchange infrastructure device is configured to recognize signal details associated with an infrastructure device and to process said details in order to present a uniform interface signal for use by a remote data processing and storage device.

42. A system for remote data exchange and processing among computing devices according to claim 24 and further comprising a core data exchange infrastructure device for wireless, two-way data transfer communication with a dedicated remote data processing and storage device comprising:
a housing;
a power supply;
a memory for data storage disposed within said housing and in electrical communication with said power supply;
a processor for processing data and presenting said data for display;
a transmitter and receiver assembly disposed within said housing and in electrical communication with said power supply for electronic wireless data exchange;
a display for presenting data in a user recognizable format; and
an interface preprogrammed within said processor for two-way data exchange communication with said remote data processing and storage device, said interface being in electrical communication with said display for presenting data from said remote data processing and storage device for a user.

43. A system for remote data exchange and processing among computing devices according to claim 42 wherein said core data exchange infrastructure device display includes a screen having a graphic user interface presented thereon.

44. A system for remote data exchange and processing among computing devices according to claim 42 wherein said core data exchange infrastructure device is formed as a personal digital assistant.

45. A core data exchange infrastructure device for wireless, two-way data transfer communication with a dedicated remote data processing and storage device comprising:
a housing;
a power supply;
a memory for data storage disposed within said housing and in electrical communication with said power supply;
a processor for processing data and presenting said data for display;
a transmitter and receiver assembly disposed within said housing and in electrical communication with said power supply for electronic wireless data exchange;
a display for presenting data in a user recognizable format; and
an interface preprogrammed within said processor for two-way data exchange communication with said remote data processing and storage device, said interface being in electrical communication with said display for presenting data from said remote data processing and storage device for a user.

46. A core data exchange infrastructure device according to claim 45 wherein said display includes a screen having a graphic user interface presented thereon.

47. A core data exchange infrastructure device according to claim 45 wherein said device is formed as a personal digital assistant.

48. A computer data signal embodied in a carrier wave for interfacing remote computing devices with data exchange infrastructure devices comprising:
computer-executable instructions for seeking a protocol announcing the presence of one or more data exchange infrastructure devices
computer-executable instructions for detecting said protocol; and
computer-executable instructions for establishing two-way data exchange communication with said at least one of said one or more data exchange infrastructure devices.

49. A computer data signal according to claim 48 and further comprising computer-executable instructions for enhancing data security.

50. A computer data signal according to claim 48 and further comprising computer-executable instructions for encrypting data.

51. A computer data signal according to claim 48 and further comprising computer-executable instructions for verifying data.

52. A computer data signal according to claim 48 and further comprising computer-executable instructions defining a virtual interface protocol for seeking, detecting and establishing two-way data exchange communication with at least one data exchange infrastructure device.

53. A computer data signal according to claim 48 and further comprises computer-executable instructions for recognizing predetermined data stream structures and to encode the data stream for more efficient transmission.

54. A computer data signal according to claim 48 and further comprises computer-executable instructions for defining an execution environment to prevent access to any remote data processing and storage device resources except the data exchange stream and a predetermined amount of storage space.

55. A computer data signal according to claim 48 and further comprises computer-executable instructions for insuring that any received input information originated with an intended data exchange infrastructure device.

56. A computer-readable media storing computer-executable instructions for interfacing remote computing devices with data exchange infrastructure devices a comprising:
computer-executable instructions for seeking a protocol announcing the presence of one or more data exchange infrastructure devices;
computer-executable instructions for detecting said protocol; and
computer-executable instructions for establishing two-way data exchange communication with said at least one of said one or more data exchange infrastructure devices.

57. A computer-readable media according to claim 56 and further comprising computer-executable instructions for enhancing data security.

58. A computer-readable media according to claim 56 and further comprising computer-executable instructions for encrypting data.

59. A computer-readable media according to claim 56 and further comprising computer-executable instructions for verifying data.

60. A computer-readable media according to claim 56 and further comprising computer-executable instructions defining a virtual interface protocol for seeking, detecting and establishing two-way data exchange communication with at least one data exchange infrastructure device.

61. A computer-readable media according to claim 56 and further comprises computer-executable instructions for recognizing predetermined data stream structures and to encode the data stream for more efficient transmission.

62. A computer-readable media according to claim 56 and further comprises computer-executable instructions for defining an execution environment to prevent access to any remote data processing and storage device resources except the data exchange stream and a predetermined amount of storage space.

63. A computer-readable media according to claim 56 and further comprises computer-executable instructions for insuring that any received input information originated with an intended data exchange infrastructure device.

64. A computer program embodied on a computer-readable media for interfacing remote computing devices with data exchange infrastructure devices comprising:
a code segment for seeking a protocol announcing the presence of one or more data exchange infrastructure devices;
a code segment for detecting said protocol; and
a code segment for establishing two-way data exchange communication with said at least one of said one or more data exchange infrastructure devices.

65. A computer program according to claim 64 and further comprising a code segment for enhancing data security.

66. A computer program according to claim 64 and further comprising a code segment for encrypting data.

67. A computer program according to claim 64 and further comprising a code segment for verifying data.

68. A computer program according to claim 64 and further comprising a code segment defining a virtual interface protocol for seeking, detecting and establishing two-way data exchange communication with at least one data exchange infrastructure device.

69. A computer program according to claim 64 and further comprises a code segment for recognizing predetermined data stream structures and to encode the data stream for more efficient transmission.

70. A computer program according to claim 64 and further comprises a code segment defining an execution environment to prevent access to any remote data processing and storage device resources except the data exchange stream and a predetermined amount of storage space.

71. A computer program according to claim 64 and further comprises a code segment for insuring that any received input information originated with an intended data exchange infrastructure device.

72. A computer data signal embodied in a carrier wave for interfacing data exchange infrastructure devices with remote data processing and storage devices comprising:
computer-executable instructions for announcing a protocol directed to any remote data processing and storage devices within a predetermined range around said data exchange infrastructure device;
computer-executable instructions for being detected by remote data processing and storage devices; and
computer-executable instructions for establishing two-way data exchange communication with said remote data processing and storage devices.

73. A computer data signal according to claim 72 and further comprising computer-executable instructions for enhancing data security.

74. A computer data signal according to claim 72 and further comprising computer-executable instructions for encrypting data.

75. A computer data signal according to claim 72 and further comprising computer-executable instructions for verifying data.

76. A computer data signal according to claim 72 and further comprising computer-executable instructions for discriminating between signals from multiple remote data processing and storage devices.

77. A computer data signal according to claim 72 and further comprising computer-executable instructions for preventing access to any data exchange infrastructure device resources except the data exchange stream and a predetermined amount of storage space.

78. A computer data signal according to claim 72 and further comprising computer-executable instructions for directing data exchange signals from one or more remote data processing and storage devices among a plurality of infrastructure devices.

79. A computer data signal according to claim 72 and further comprising computer-executable instructions for recognizing signal details associated with an infrastructure device and to process said details in order to present a uniform interface signal for use by a remote data processing and storage device.

80. A computer-readable media storing computer-executable instructions for interfacing data exchange infrastructure devices with remote data processing and storage devices comprising:
computer-executable instructions for announcing a protocol directed to any remote data processing and storage devices within a predetermined range around said data exchange infrastructure device;
computer-executable instructions for being detected by remote data processing and storage devices; and
computer-executable instructions for establishing two-way data exchange communication with said remote data processing and storage devices.

81. A computer-readable media according to claim 80 and further comprising computer-executable instructions for enhancing data security.

82. A computer-readable media according to claim 80 and further comprising computer-executable instructions for encrypting data.

83. A computer-readable media according to claim 80 and further comprising computer-executable instructions for encrypting data.

84. A computer-readable media according to claim 80 and further comprising computer-executable instructions for discriminating between signals from multiple remote data processing and storage devices.

85. A computer-readable media according to claim 80 and further comprising computer-executable instructions for preventing access to any data exchange infrastructure device resources except the data exchange stream and a predetermined amount of storage space.

86. A computer-readable media according to claim 80 and further comprising computer-executable instructions for directing data exchange signals from one or more remote data processing and storage devices among a plurality of infrastructure devices.

87. A computer-readable media according to claim 80 and further comprising computer-executable instructions for recognizing signal details associated with an infrastructure device and to process said details in order to present a uniform interface signal for use by a remote data processing and storage device.

88. A computer program embodied on a computer-readable media for interfacing data exchange infrastructure devices with remote data processing and storage devices comprising:
a code segment for announcing a protocol directed to any remote data processing and storage devices within a predetermined range around said data exchange infrastructure device;
a code segment for being detected by remote data processing and storage devices; and
a code segment for establishing two-way data exchange communication with said remote data processing and storage devices.

89. A computer program according to claim 88 and further comprising a code segment for enhancing data security.

90. A computer program according to claim 88 and further comprising a code segment for encrypting data.

91. A computer program according to claim 88 and further comprising a code segment for verifying data.

92. A computer program according to claim 88 and further comprising a code segment for discriminating between signals from multiple remote data processing and storage devices.

93. A computer program according to claim 88 and further comprising a code segment for preventing access to any data exchange infrastructure device resources except the data exchange stream and a predetermined amount of storage space.

94. A computer program according to claim 88 and further comprising a code segment for directing data exchange signals from one or more remote data processing and storage devices among a plurality of infrastructure devices.

95. A computer program according to claim 88 and further comprising a code segment instructions for recognizing signal details associated with an infrastructure device and to process said details in order to present a uniform interface signal for use by a remote data processing and storage device.

96. A method for commercially facilitating data use, exchange and processing comprising the steps of:
providing at least one remote data processing and storage device for wireless data exchange, said remote data processing and storage device including a transmitter and receiver assembly, a microprocessor and a virtual interface preprogrammed in said microprocessor with a protocol for seeking, detecting and establishing two-way data exchange communication with at least one data exchange infrastructure device;
providing at least one data exchange infrastructure device for wireless data exchange with said at least one remote data processing and storage device including a transmitter and receiver assembly and an interface assembly in electrical communication with said transmitter and receiver assembly, and preprogrammed for announcing a protocol directed to any remote data processing and storage devices within a predetermined range around said data exchange infrastructure device, being detected thereby and establishing two-way data exchange communication therewith; and
charging a fee for users of said at least one remote data processing and storage device using said at least one data exchange infrastructure device.

97. A method for commercially facilitating data use, exchange and processing according to claim 96 and further comprising the step of providing a core data exchange infrastructure device for wireless, two-way data transfer communication with a dedicated remote data processing and storage device, said core data exchange infrastructure device including a processor for processing data and presenting said data for display; a transmitter and receiver assembly disposed within said housing and in electrical communication with said power supply for electronic wireless data exchange; a display for presenting data in a user recognizable format and an interface preprogrammed within said processor for two-way data exchange communication with said remote data processing and storage device, said interface being in electrical communication with said display for presenting data from said remote data processing and storage device for a user.

98. A method for commercially facilitating data use, exchange and processing according to claim 96 and further comprising the step of using at least one data exchange infrastructure device to coordinate and direct data signals among predetermined data exchange infrastructure devices and remote data processing and storage devices.

99. A method for commercially facilitating data use, exchange and processing according to claim 96 and further comprising the step of providing at least one data exchange infrastructure device configured to meter transmission channel usage and to allocate system resources in accordance with said metered transmission channel usage.

100. A method for commercially facilitating data use, exchange and processing according to claim 96 wherein said method includes the steps of conducting a commercial sales transaction using at least one data exchange device and at least one remote data processing and storage device; establishing a two-way data exchange; delivering a data product to a buyer using said two-way data exchange; and charging said buyer for said data product.

101. A method for commercially facilitating data use, exchange and processing according to claim 96 wherein said step of charging said buyer includes transferring payment using said two-way data exchange.

102. A method for commercially facilitating data use, exchange and processing according to claim 96 wherein said method includes the step of providing a security arrangement operatively associated with said data exchange infrastructure device.

103. A method for commercially facilitating data use, exchange and processing according to claim 96 wherein said step of providing a security arrangement includes providing a data verification arrangement.

104. A method for commercially facilitating data use, exchange and processing according to claim 103 and further comprising the step of charging a fee for utilization of said data verification arrangement.

105. A method for facilitating commercial sales transactions of data products comprising the steps of:
providing at least one remote data processing and storage device for wireless data exchange, said remote data processing and storage device including a transmitter and receiver assembly, a microprocessor and a virtual interface preprogrammed in said microprocessor with a protocol for seeking, detecting and establishing two-way data exchange communication with at least one data exchange infrastructure device;
providing at least one data exchange infrastructure device for wireless data exchange with said at least one remote data processing and storage device including a transmitter and receiver assembly and an interface assembly in electrical communication with said transmitter and receiver assembly, and preprogrammed for announcing a protocol directed to any remote data processing and storage devices within a predetermined range around said data exchange infrastructure device, being detected thereby and establishing two-way data exchange communication therewith;
transferring a data product to a buyer using said two-way data exchange; and
charging buyers for any data products obtained during two-way data exchange.

106. A method for facilitating commercial sales transactions of data products according to claim 105 and further comprising the step of providing a core data exchange infrastructure device for wireless, two-way data transfer communication with a dedicated remote data processing and storage device, said core data exchange infrastructure device including a processor for processing data and presenting said data for display; a transmitter and receiver assembly disposed within said housing and in electrical communication with said power supply for electronic wireless data exchange; a display for presenting data in a user recognizable format and an interface preprogrammed within said processor for two-way data exchange communication with said remote data processing and storage device, said interface being in electrical communication with said display for presenting data from said remote data processing and storage device for a buyer.

107. A method for facilitating commercial sales transactions of data products according to claim 105 and further comprising the step of using at least one data exchange infrastructure device to coordinate and direct data signals among predetermined data exchange infrastructure devices configured for distribution of data products and remote data processing and storage devices.

108. A method for facilitating commercial sales transactions of data products according to claim 105 wherein said step of charging said buyer includes transferring payment using said two-way data exchange.

109. A method for facilitating commercial sales transactions of data products according to claim 105 wherein said method includes the step of providing a security arrangement operatively associated with said data exchange infrastructure device.

110. A method for facilitating commercial sales transactions of data products according to claim 105 wherein said step of providing a security arrangement includes providing a data verification arrangement.

111. A method for facilitating commercial sales transactions of data products according to claim 110 and further comprising the step of charging a fee for utilization of said data verification arrangement.
